(19) United States
(12) Patent Application Publication
(10) Pub. No.: US 2006/0157031 A1
(43) Pub. Date: Jul. 20, 2006

(54) Fuel injection rail

(75) Inventor: Mitsuo Kaishio, Koga-Shi (JP)

Correspondence Address: LADAS & PARRY, 26 WEST 61ST STREET, NEW YORK, NY, 10023, US

(73) Assignee: SANOH KOGYO KABUSHIKI KAISHA

(21) Appl. No.: 11/315,953

(22) Filed: Dec. 22, 2005

(30) Foreign Application Priority Data
Jan. 19, 2005 (JP) 2005-12058

(51) Int. Cl. F02M 69/46

(52) U.S. Cl. 123/456; 123/468

(57) ABSTRACT

A fuel injection rail includes a rail body including an upper case 30 made of a metal and an injector holding member 32 made of a resin, provided in its outer surface with recesses 35 in which holding parts 37 of the upper case 30 engage and a sealing groove 38 spaced from the recesses 35; and sealing means 39 placed in the sealing groove 38 to seal the joint between the upper case 30 and the injector holding member 32. The fuel injection rail can be readily assembled. The joint between the upper case 30 and the injector holding member 32 is sealed with high reliability.

### BACKGROUND OF THE INVENTION

1. Field of the Invention

The present invention relates to a fuel injection rail included in a fuel injection system for an automotive engine.

1. Description of the Related Art

In a fuel supply system for supplying fuel to an automotive engine, a fuel pump pumps fuel through a fuel supply pipe into a fuel injection rail, fuel is distributed to fuel injectors attached to the fuel injection rail, and the fuel injectors injects fuel into an intake manifold connected to the engine.

Most of the fuel injection. rails of this type have been made of a metal. Resin fuel injection rails and composite fuel injection rails each formed by combining a metal part and a resin part have been developed in recent years. FIGS. 11 and 12 show a known composite fuel injection rails disclosed in JP-U 5-43355(Patent document 1).

Referring to FIGS. 11 and 12, a rail body 1, namely, a main part, of a fuel injection rail 10 has a wall 3 provided with sockets 4 respectively for holding injectors, side walls 21 and 22 and a top wall 23. The sockets 4 projects downward from the flat surface of the wall 3 perpendicularly to the flat surface. The wall 3 is made of a resin by molding. The side walls 21 and 22 and the top wall 23 are formed by forming a steel plate. The sockets 4 are formed iritegrally with the wall 3. A lower part of each of the side walls 21 and 22 of the main pipe 1 is bent outward and then inward in a channel defining a groove 5. Edges of the wall 3 are engaged in the grooves 5 of the channels. A sealing member 6 is held between the wall 3 and walls of the channels. The wall 3 and the main pipe 1 are fastened together by staking the channels of the main pipe 1.

The sockets 4 are formed at correct positions and are arranged at correct intervals in the main pipe 1 having the metal walls and the resin wall, namely, the wall 3, and the main pipe 1 is a lightweight structure.

When the main pipe 1 is built by fastening resin wall 3 to the side walls 21 and 22 by staking as mentioned in Patent document 1, a bending process for bending the lower parts of the side walls 21 and 22 of the main pipe 1 to form the grooves 5 need to be managed strictly to provide the sealing member 6 with a uniform staking allowance for a satisfactory sealing effect. However, it is practically difficult to achieve such a strictly managed bending process during a mass production process, and it is actually impossible to achieve reliable sealing during the mass production process.

Reliable sealing by the sealing member 6 and bending and staking the side walls 21 and 22 to fasten the sealing member 6 to the main pipe 1 are inseparably related to each other. Consequently, reliable sealing and high-volume production capability have been incompatible.

The highly difficult processes, namely, the process for forming the grooves and the staking process, complicate the manufacturing process.

Accordingly, it is an object of the present invention to solve those problems in the prior art and to provide a fuel injection rail having a rail body including a metal part and a resin part, capable of being easily assembled and having a reliably sealed joint between the resin part and a metal part.

### SUMMARY OF THE INVENTION

The present invention provides a fuel injection rail including a rail body including an upper case made of a metal, defining a space for carrying fuel and provided with holding parts, and an injector holding member made of a resin, having sockets for holding injectors therein, provided in its outer surface with recesses in which the holding parts of the upper case engage and a sealing groove spaced from the recesses; and sealing means placed in the sealing groove to seal the joint between the upper case and the injector holding member, wherein a dimension of a seal holding part of the injector holding member and inside dimensions of the upper case are determined such that a predetermined squeeze allowance by which the sealing means is compressed is available.

In the fuel injection rail according to the present invention, the dimension of the seal holding part is distance between bottom surfaces of opposite parts of the sealing groove.

The predetermined squeeze allowance is a dimension by which the sealing means placed in the sealing groove is compressed to exercise a necessary and sufficient sealing effect.

In the fuel injection rail according to the present invention, the inside dimension of the upper case is equal to a value obtained by subtracting twice the predetermined squeeze allowance from the sum of twice an outside diameter of the sealing means and the dimension of the seal holding part.

In the fuel injection rail according to the present invention, the opposite side walls of the upper case press the sealing means placed in the sealing groove elastically.

In the fuel injection rail according to the present invention, the injector holding member has a positioning part that comes into contact with the upper wall of the upper case to position the recesses of the injector holding member relative to the upper case.

In the fuel injection rail according to the present invention, the positioning part that comes into contact with the upper wall of the upper case has a flat cross section.

In the fuel injection rail according to the present invention, the positioning part that comes into contact with the upper wall of the upper case has a bar-shaped cross section.

In the fuel injection rail according to the present invention, the positioning part has a first contact part of a bar-shaped cross section that comes into contact with the upper wall of the upper case and a second contact part of a flat cross section that comes into contact with the upper wall of the upper case.

In the fuel injection rail according to the present invention, the injector holding member is pressed into the upper case as deep as the positioning projection comes into contact with the upper wall of the upper case.

In the fuel injection rail according to the present invention, the injector holding member is provided on its bottom surface with a deformation preventing part that engages with longitudinal, lower edge parts of the longitudinal side walls of the upper case to prevent the longitudinal side walls of the upper case from being bulged out by pressure in the upper case.

In the fuel injection rail according to the present invention, the sealing means is a plurality of sealing members mounted in a vertical arrangement on the injector holding member.

In the fuel injection rail according to the present invention, the holding parts are hooks formed by inwardly bending parts of the side walls of the upper case inward.

In the fuel injection rail according to the present invention, the holding parts are projections formed by inwardly protruding parts of the side walls of the upper case.

The fuel injection rail according to the present invention is easy to assemble, and the inside dimension of the upper case and the dimension of the seal holding part of the injector holding member can be easily managed. Therefore, the fuel injection rail has highly reliable sealing ability even if the fuel injection rail is mass-produced.

The sealing groove formed in the outer surface of the injector holding member is spaced from the recess. Therefore, the reliable sealing effect of the sealing member can be achieved separately from the bending process for fixing the sealing member, the side walls do not need to be bent and staked to fix the sealing member, and the sealing member is able to exercise its reliable sealing ability.

### BRIEF DESCRIPTION OF THE DRAWINGS

The above and other objects, features and advantages of the present invention will become more apparent from the following description taken in connection with the accompanying drawings, in which:

FIG. 1 is a partly cutaway side elevation of a fuel injection rail in a first embodiment according to the present invention;

FIG. 2 is a cross-sectional view of the fuel injection rail in the first embodiment;

FIG. 3 is a cross-sectional view of the fuel injection rail in the first embodiment for assistance in explaining a method of assembling the fuel injection rail in the first embodiment;

FIG. 4 is a cross-sectional view of the fuel injection rail in the first embodiment for assistance in explaining another method of assembling the fuel injection rail in the first embodiment;

FIG. 5 is a partly cutaway side elevation of a fuel injection rail in a second embodiment according to the present invention;

FIG. 6 is a cross-sectional view of the fuel injection rail in the second embodiment;

FIG. 7 is a cross-sectional view of a fuel injection rail in a modification of the fuel injection rail in the second embodiment;

FIG. 8 is a cross-sectional view of a fuel injection rail in a third embodiment according to the present invention;

FIG. 9 is a cross-sectional view of a fuel injection rail in a modification of the fuel injection rail in the third embodiment;

FIG. 10 is a cross-sectional view of a fuel injection rail in a fourth embodiment according to the present invention;

FIG. 11 is a longitudinal sectional view of a prior art fuel injection rail; and

FIG. 12 is a cross-sectional view of the fuel injection rail shown in FIG. 11.

### DESCRIPTION OF THE PREFERRED EMBODIMENTS

### First Embodiment

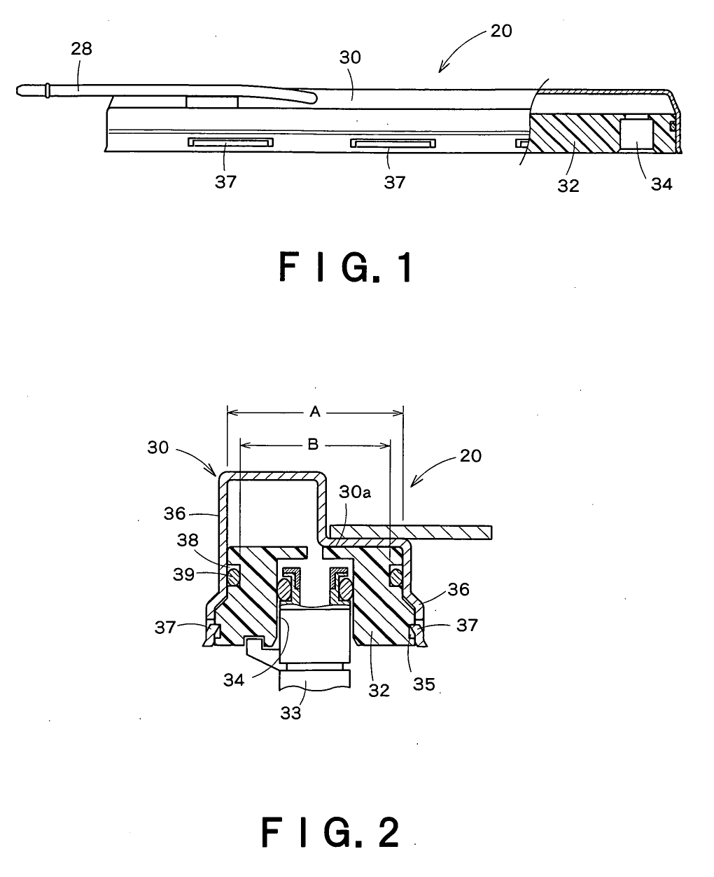

FIGS. 1 and 2 are a partly cutaway side elevation and a cross-sectional view, respectively, of a fuel injection rail in a first embodiment according to the present invention.

Referring to FIGS. 1 and 2, the fuel injection rail has a rail body 20 formed by combining an upper case 30 made of a metal and an injector holding member 32 made of a resin.

The upper case 30 is formed by subjecting a stainless steel plate to press working, such as deep drawing. The upper case 30 has the shape of an elongate, bottomed case defining a fuel carrying space for carrying fuel supplied thereto through a fuel supply pipe 28. The injector holding member 32 is an elongate plate formed by injection molding. An open side of the upper case 30 is covered with the injector holding member 32. As shown in FIG. 2, the injector holding member 32 is provided with a plurality of cylindrical sockets 34. An injector is pressed into each of the sockets 34.

The upper case 30 and the injector holding member 32 can be readily assembled simply by fitting the injector holding member 32 in the upper case 30. The injector holding member 32 is provided in its peripheral surface with a peripheral retaining groove 35. The upper case 30 is provided on its longitudinal side walls 36 with catching projections 37 having a length along a longitudinal direction. The catching projections 37 are formed by bending parts of the side walls 36 inward. When the injector holding member 32 is fitted in the upper case 30, the catching projections 37 are elastically warped outward to enable the injector holding member 32 to be easily fitted in the upper case 30.

The upper surface of the injector holding member 32 comes into contact with an upper wall 30a of the upper case 30 to position the peripheral retaining groove 35 properly relative to the upper case 30. Upon the contact of the upper surface of the injector holding member 32 with the upper wall 30a, the catching projections 37 engage in the peripheral retaining groove 35.

The injector holding member 32 is provided in its peripheral surface with a peripheral sealing groove 38. The sealing groove 38 is spaced from the peripheral retaining groove 35. A sealing member 39 is placed in the peripheral sealing groove 38 for the liquid-tight sealing of the joint between the upper case 30 and the injector holding member 32.

The inside dimensions of the upper case 30 and the dimensions of a sealing member holding part including the sealing groove 38 of the injector holding member 32 are determined so as to provide a squeeze allowance, i.e., a dimension by which the sealing member 39 needs to be compressed for a necessary and sufficient sealing effect. Consequently, the joint between the upper case 30 and the injector holding member 32 can be sealed by a reliable sealing effect simply by fitting the injector holding member 32 in the upper case 30. For example, a difference between the lateral inside width A of the upper case 30 and the distance B between the bottom surfaces of opposite side parts of the peripheral sealing groove 38 in FIG. 2 dominates the sealing effect of the sealing member 39. When the lateral inside width A and the distance B are determined so as to provide a proper squeeze allowance by which the sealing member 39 is compressed, the sealing member 39 exhibits a reliable sealing ability. This fact applies also to the relation between the longitudinal inside width of the upper case 30 and the distance between the bottoms of the opposite longitudinal end parts of the peripheral sealing groove 38. The lateral inside width A of the upper case 30 is equal to a value obtained by subtracting twice a predetermined squeeze allowance, by which the sealing member 39 is to be compressed to achieve reliable sealing, from the sum of the distance B between the bottom surfaces of opposite side parts of the peripheral sealing groove 38 and twice the diameters of the sealing member 39. The opposite side walls 36 of the upper case 30 compress the sealing member 32 placed in the sealing groove 38 to seal the joint between the upper case 30 and the injector holding member 32.

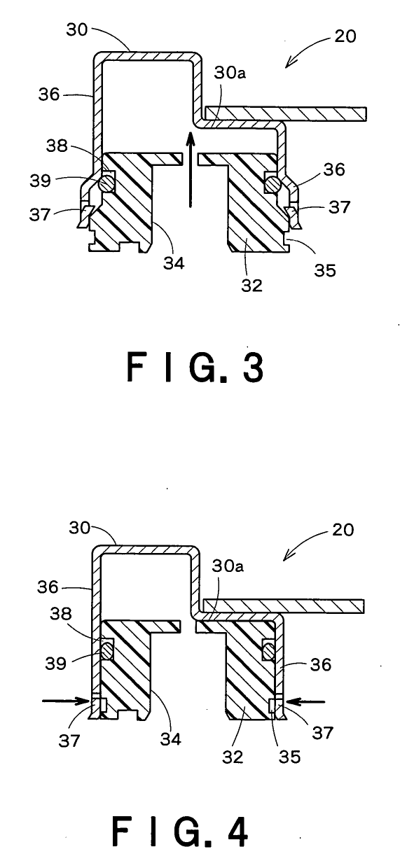

As shown in FIG. 3, the sealing member 39 is mounted on the injector holding member 32, and then the injector holding member 32 is fitted in the upper case 30 as deep as the upper surface of the injector holding member 32 comes into contact with the upper wall 30a of the upper case 30. The upper surface of the injector holding member 32 serves as a flat butt surface.

When the catching hooks 37 engage in the peripheral retaining groove 35 as shown in FIG. 2, the injector holding member 32 is fixedly joined to the upper case 30 and the sealing member 39 is compressed properly to seal the joint between the upper case 30 and the injector holding member 32 effectively.

Thus the fuel injection rail can be readily assembled simply by fitting the injector holding member 32 in the upper case 30. Since the inside dimensions of the upper case 30 and the dimensions of the sealing member holding part of the injector holding member 32 can be easily managed in the mass production of the fuel injection rail, the fuel injection rail manufactured by a mass production system is sealed with high reliability.

Parts of the side walls of the upper case 30 may be pressed inward to form the catching hooks 37 as shown in FIG. 4 after the injector holding member 32 has been fitted in the upper case 30.

### Second Embodiment

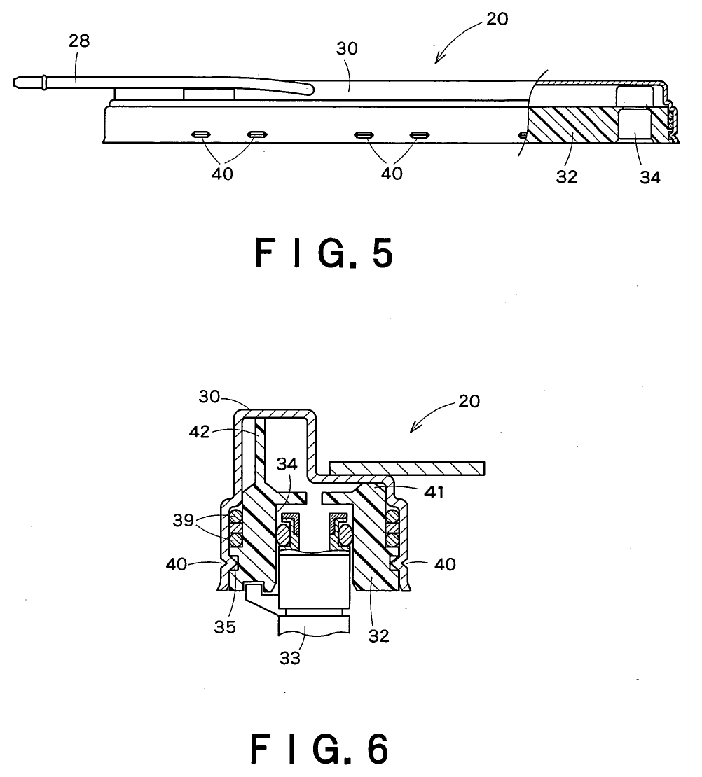

FIGS. 5 and 6 are a partly cutaway side elevation and of a cross-sectional view, respectively, of a fuel injection rail in a second embodiment according to the present invention.

The fuel injection rail in the second embodiment is provided with a plurality of longitudinally arranged ridges 40 for fastening together an upper case 30 and an injector holding member 32 instead of the catching projections 37. As shown in FIG. 6, the ridges 40 protrude from the inside surfaces of the longitudinal side walls of the upper case 30. The number and positions of the ridges 40 are dependent on required fixing strength.

The injector holding member 32 are provided in its longitudinal side surfaces with recesses 35 at positions corresponding to the ridges 40. When the injector holding member 32 is fitted in the upper case 30, the ridges 40 engage in the recesses 35, respectively.

The injector holding member 32 of the fuel injection rail in the second embodiment is similar to the injector holding member 32 of the fuel injection rail in the first embodiment in that the injector holding member 32 is provided with the recesses 35 in which the ridges engage, and the inside dimensions of the upper case 30 and the dimensions of a sealing member holding part of the injector holding member 32 are determined so as to provide a proper squeeze allowance by which sealing members 39 need to be compressed.

The fuel injection rail in the second embodiment is provided with the two sealing members 39. The injector holding member 32 is provided with a first protrusion 41 having a bar-shaped cross section and a plate-shaped second protrusion 42. The first protrusion 41 and the second protrusion 42 are formed integrally with the injector holding member 32 so as to position the recesses 35 properly relative to the upper case 30.

The fuel injection rail in the second embodiment, similarly to the fuel injection rail in the first embodiment, can be readily assembled simply by fitting the injector holding member 32 in the upper case 30. The two sealing members 39 ensure further reliable sealing even if the fuel injection rail is mass-produced.

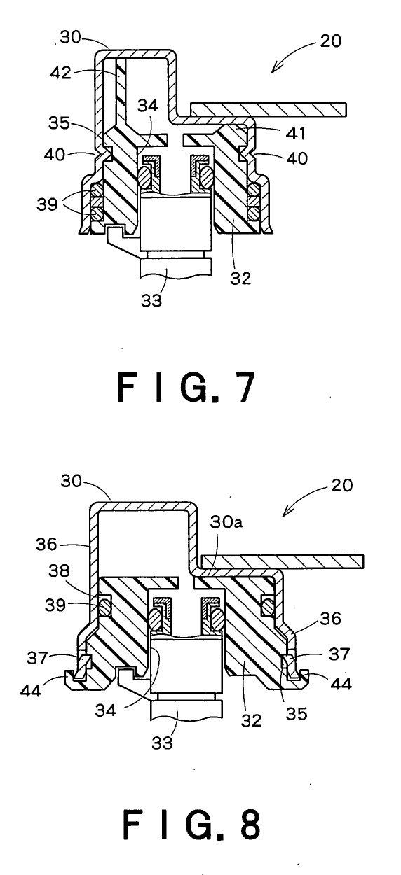

The sealing members 39 may be placed at levels above that of the recesses 35 as shown in FIG. 6 or may be placed at levels below that of the recesses 35 as shown in FIG. 7.

### Third Embodiment

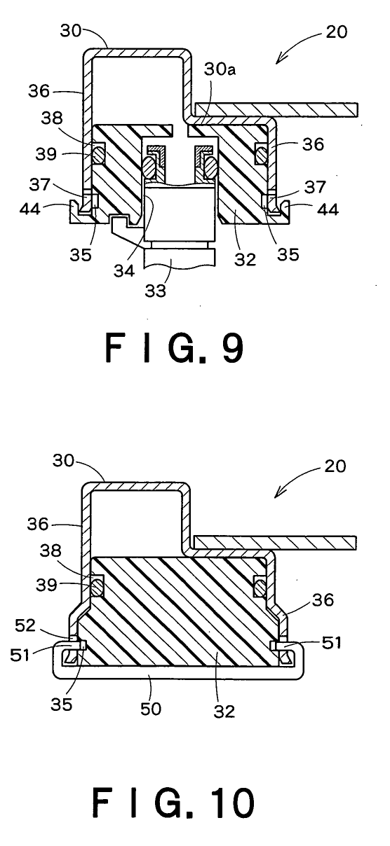

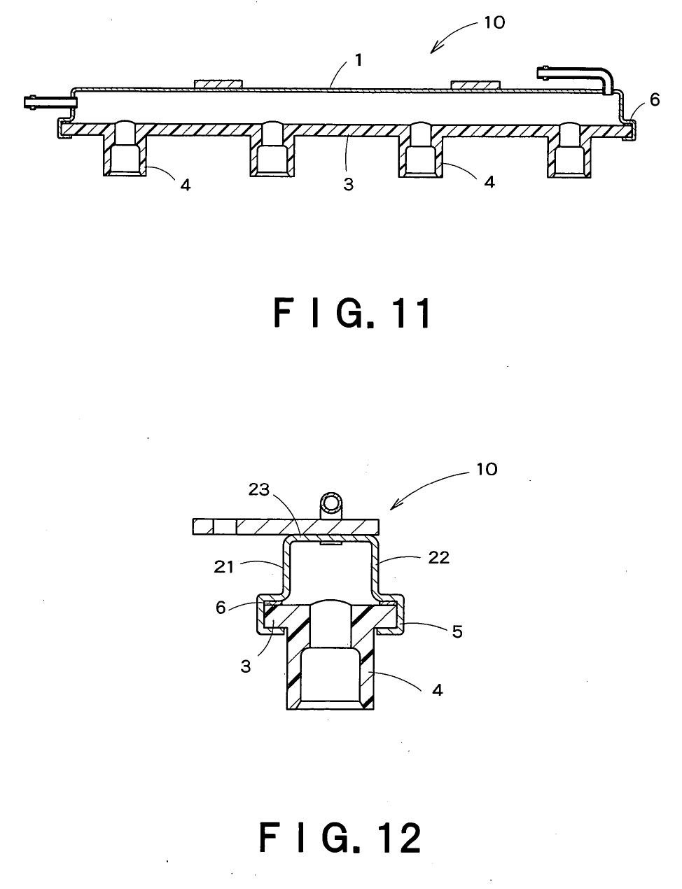

FIGS. 8 and 9 show a fuel injection rail in a third embodiment according to the present invention.

An injector holding member 32 included in the fuel injection rail in the third embodiment is formed by incorporating an improvement into the injector holding member 32 of the first embodiment to prevent the reduction of the sealing effect of a sealing member when an upper case 30 is deformed by the pressure of the fuel supplied into the fuel injection rail.

Referring to FIG. 8, the injector holding, member 32 is integrally provided with a deformation preventing part 44 laterally protruding from the lower surface of the injector holding member 32 so as to surround the periphery of a lower part of the injector holding member 32. The deformation preventing part 44 is formed in a U-shaped cross section defining a peripheral groove. When the injector holding member 32 is fitted in and fixedly joined to the upper case 30, lower parts of the longitudinal side walls 36 and end walls of the upper case 30 engage closely in the groove defined by the deformation preventing part 44.

In some cases, the longitudinal side walls 36 of the upper case 30 are caused to bulge out by the pressure of the fuel supplied into the fuel injection rail. The sealing effect of a sealing member drops significantly if the longitudinal side walls 36 bulge out. Since the lower edge part of the longitudinal side walls 36 of the upper case 30 are cramped up by the deformation preventing part 44, the longitudinal side walls 36 are prevented from being bulged out and hence the sealing effect of the sealing member 39 will not be deteriorated. The deformation preventing part 44 does not need to be formed so as to surround entirely the lower part of injector holding member 32 and may be formed only at necessary parts. An individual deformation preventing member may be attached to the injector holding member 32 instead of forming the deformation preventing part 44 integrally with the injector holding member 32.

FIG. 9 shows an injector holding member 32 formed by forming a deformation preventing part 44 integrally with the injector holding member 32 shown in FIG. 4.

### Fourth Embodiment

FIG. 10 shows a fuel injection rail in a fourth embodiment according to the present invention.

As shown in FIG. 10, an injector holding member 32 is fastened to an upper case 30 by a necessary number of fastening members 50.

The fastening members 50 are placed on the injector holding member 32 at positions not corresponding to sockets 34 (FIG. 1). Each fastening member 50 is formed in a U-shape and has opposite side walls provided with catching hooks 51. The upper case 30 has longitudinal side walls 36 provided with openings 52. When the fastening member 50 is put on the injector holding member 32, the catching hooks 51 extend through the openings 52 and project inside the upper case 30 and engage in recesses 35 formed in the injector holding member 32. The inside dimensions of the upper case 30 and the dimensions of a sealing member holding part of the injector holding member 32, similarly to those of the first embodiment, are determined so as to provide a proper squeeze allowance by which sealing members 39 need to be compressed.

The fuel injection rail in the fourth embodiment, similarly to the fuel injection rail in the first embodiment, can be readily assembled simply by fitting the injector holding member 32 in the upper case 30. The two sealing members 39 ensure further reliable sealing even if the fuel injection rail is mass-produced.

What is claimed is:

1. A fuel injection rail comprising:
a rail body including an upper case made of a metal, defining a space for carrying fuel and provided with holding parts, and an injector holding member made of a resin, having sockets for holding injectors therein, provided in its outer surface with recesses in which the holding parts of the upper case engage and a sealing groove spaced from the recesses; and
sealing means placed in the sealing groove to seal the joint between the upper case and the injector holding member.

2. The fuel injection rail according to claim 1, wherein a dimension of a seal holding part of the injector holding member and inside dimensions of the upper case are determined such that a predetermined squeeze allowance by which the sealing means is compressed is available.

3. The fuel injection rail according to claim 2, wherein the dimension of the seal holding part is distance between bottom surfaces of opposite parts of the sealing groove.

4. The fuel injection rail according to claim 2, wherein the predetermined squeeze allowance is a dimension by which the sealing means placed in the sealing groove is compressed to exercise a necessary and sufficient sealing effect.

5. The fuel injection rail according to claim 4, wherein the inside dimension of the upper case is equal to a value obtained by subtracting twice the predetermined squeeze allowance from the sum of twice an outside diameter of the sealing means and the dimension of the seal holding part.

6. The fuel injection rail according to claim 1, wherein, opposite side walls of the upper case press the sealing means placed in the sealing groove elastically.

7. The fuel injection rail according to claim 1, wherein the injector holding member has a positioning part that comes into contact with an upper wall of the upper case to position the recesses of the injector holding member relative to the upper case.

8. The fuel injection rail according to claim 7, wherein the positioning part that comes into contact with the upper wall of the upper case has a flat cross section.

9. The fuel injection rail according to claim 7, wherein the positioning part that comes into contact with the upper wall of the upper case has a bar-shaped cross section.

10. The fuel injection rail according to claim 7, wherein the positioning part has a first contact part of a bar-shaped cross section that comes into contact with the upper wall of the upper case and a second contact part of a flat cross section that comes into contact with the upper wall of the upper case.

11. The fuel injection rail according to claim 7, wherein the injector holding member is pressed into the upper case as deep as the positioning projection comes into contact with the upper wall of the upper case.

12. The fuel injection rail according to claim 1, wherein the injector holding member is provided on its bottom surface with a deformation preventing part that engages with longitudinal, lower edge parts of the longitudinal side walls of the upper case to prevent the longitudinal side walls of the upper case from being bulged out by pressure in the upper case.

13. The fuel injection rail according to claim 1, wherein the sealing means is a plurality of sealing members and the sealing members are mounted in a vertical arrangement on the injector holding member.

14. The fuel injection rail according to claim 1, wherein the holding parts are hooks formed by inwardly bending parts of the side walls of the upper case inward.

15. The fuel injection rail according to claim 1, wherein the holding parts are projections formed by inwardly protruding parts of the side walls of the upper case.
